(19) United States
(12) Patent Application Publication
(10) Pub. No.: US 2016/0133352 A1
(43) Pub. Date: May 12, 2016

(54) INSULATING HEAT-CONDUCTIVE SHEET

(71) Applicant: TOYOBO CO., LTD., Osaka (JP)

(72) Inventors: Kana HASHIMOTO, Otsu-shi, Shiga (JP); Etsuko KOUMON, Otsu-shi, Shiga (JP); Akinori Ejima, Otsu-shi, Shiga (JP)

(73) Assignee: TOYOBO CO., LTD., Osaka (JP)

(21) Appl. No.: 14/899,337

(22) PCT Filed: Jun. 19, 2014
(86) PCT No.: PCT/JP2014/066246

§ 371 Date: Dec. 17, 2015

(30) Foreign Application Priority Data
Jun. 19, 2013 (JP) 2013-128688
Jun. 27, 2013 (JP) 2013-134639

(51) Int. Cl. H01B 3/46; H01B 3/48; H01B 3/30

(52) U.S. Cl. CPC H01B 3/46; H01B 3/302; H01B 3/48

(57) ABSTRACT

An object is to provide a heat-conductive sheet being excellent in insulation properties and thermal anisotropy and having high heat-dissipating properties. An insulating heat-conductive sheet including insulating highly heat-conductive fibers penetrating in a thickness direction of the sheet and a binder resin, wherein the insulating highly heat-conductive fibers penetrating in the thickness direction have a penetration density greater than or equal to 6%, and the insulating heat-conductive sheet has a ratio of thermal conductivity in the thickness direction to thermal conductivity in a planar direction greater than or equal to 2, and an initial dielectric breakdown strength greater than or equal to 20 kV/mm.

### TECHNICAL FIELD

The present invention relates to an insulating heat-conductive sheet having electrical insulation properties and high thermal anisotropy. More particularly, the present invention relates to an insulating heat-conductive sheet capable of conducting heat selectively in a specific direction from a heat generator such as an electronic board, a semiconductor chip and a light source while ensuring the insulation reliability.

### BACKGROUND ART

In recent years, importance of measures for heat dissipation has been growing due to an increase in exothermic density of electronic equipment associated with the thinning, shortening and downsizing of the electronic equipment or the highly enhanced output thereof. In order to alleviate a trouble by heat of electronic equipment, it is important to promptly release heat generated in the equipment to a heat dissipator such as a cooling member or a housing so as not to adversely affect a peripheral member, and a member capable of conducting heat in a specific direction has been desired. As a method of dissipating heat generated from a heat generator such as a semiconductor or an LED, it is general to attach a heat dissipator made of a metal such as aluminum and copper thereto. However, in general, since the metal has electric conductivity, a heat-conductive member is also required to have electrical insulation properties in many cases in order to prevent a trouble due to an electric leakage to a cooling member or a housing. In the case where electrical insulation properties are required, an insulating material made of a metal oxide, a resin or the like is inserted between a heat generator and a heat dissipator. In particular, from the viewpoints of the moldability and the abutting property, recently, there have been many cases in which a resin material is favored. In this context, there is a great problem that a resin material generally has low heat conductivity and the heat dissipating properties are lowered. As such, there has hitherto been proposed a production technique for the heat-conductive member achieving both electrical insulation properties and heat conductivity in which a resin material is filled with an insulating heat-conductive filler such as metal oxide fine particles. Furthermore, since the heat-conductive member is mainly sandwiched between a heat source and a cooling member to be used, in the case where the heat-conductive member is a sheet, high heat conductivity is required in the thickness direction of the sheet. In order to allow the sheet to exhibit thermal anisotropy in the thickness direction thereof, it is necessary to orient the heat conducting direction of the heat-conductive filler in the thickness direction.

As such a technique, in PTD 1 and PTD 2, an organic fiber or a metal nitride achieving both electrical insulation properties and heat conductivity is oriented in a binder resin by electrostatic flocking or the action of a magnetic field. However, in the case of being oriented by the action of a magnetic field, when the amount of the heat-conductive filler added is large, the fiber or metal nitride becomes difficult to be oriented since the resin viscosity is increased. Moreover, in the case of electrostatic flocking, the volume fraction of flocked fibers in the sheet is 6% or so due to electrostatic repulsion and physical repulsion between fibers, and sufficient thermal anisotropy is not attained. On the other hand, in PTD 3, it is stated that the flocking basis weight is generally approximately 100 to 150 g/m² irrespective of the thickness and the length of the flocking short fiber in a usual electrostatic flocking technique, and for example, in the case where a short fiber with a density of 1.2 g/cm³ and a fiber length of 0.4 mm is used, it follows that the fiber volume fraction relative to the whole sheet volume corresponds to 30%. However, a conventional electrostatic flocking technique is generally utilized as a production technique for a napped material used in clothes, carpets, heat insulating materials or the like, extremely erected fibers have not been pursued and many largely tilted fibers are contained. On that account, in the case where a conventional electrostatic flocking technique is utilized to produce an insulating heat-conductive sheet, since tilted fibers fail to penetrate in the thickness direction of the sheet, high penetration density, namely high thermal anisotropy, is not attained.

Furthermore, in PTD 4, a method of shrinking a flocked sheet after electrostatic flocking to increase the flocking density is described. Actually, since many largely tilted fibers are contained as described above, wrinkles and flexure are generated due to the collision between fibers at the time of shrinking the sheet and a high flocking density is not attained.

In view of these circumstances, in PTD 5, there has been proposed a method of orienting the crystal plane of a filler having high heat conductivity in the sheet planar direction by stretch orientation and allowing the sheets to be layered and then to be sliced in the thickness direction. However, since the matrix resin layer interposed between pieces of filler inhibits heat from being conducted, sufficiently high thermal anisotropy commensurate with the filling ratio is not attained.

Moreover, in general, with regard to a fibrous heat-conductive material, the orientation properties of its molecules are enhanced in the fiber axis direction to exhibit high heat conductivity, and macromolecules in which such an orientation is attained often have a molecular chain high in rigidity, do not have a functional group exerting an interaction with other substances, and are poor in wettability with a binder resin. On that account, by being exposed to a high temperature or frequent changes in temperature in a practical use environment, interfacial peeling between a heat-conductive material and a binder resin occurs and the dielectric breakdown strength is sometimes lowered. When the dielectric breakdown strength is lowered, dielectric breakdown becomes easy to occur, resulting in a failure of equipment.

### CITATION LIST

### Patent Document

PTD 1: Japanese Patent Laying-Open No. 2002-88171
PTD 2: Japanese Patent No. 4521937
PTD 3: Japanese Patent Laying-Open No. 8-299890
PTD 4: Japanese Patent Laying-Open No. 61-179382
PTD 5: Japanese Patent Laying-Open No. 2011-184663

### SUMMARY OF INVENTION

### Technical Problem

Based on the problems in the conventional art, the present invention has been made. That is, an object of the present invention is to provide an insulating heat-conductive sheet being excellent in reliability of electrical insulation properties and having high heat conductivity.

### Solution to Problem

The present inventors have conducted diligent studies, and as a result, they have found that it is possible to solve the above-mentioned problems by means described below. Thus, the present invention has been completed.

That is, the present invention has the following configuration.

1. An insulating heat-conductive sheet including insulating highly heat-conductive fibers penetrating in a thickness direction of the sheet and a binder resin, wherein the insulating highly heat-conductive fibers penetrating in the thickness direction have a penetration density greater than or equal to 6%, and the insulating heat-conductive sheet has a ratio of thermal conductivity in the thickness direction to thermal conductivity in a planar direction greater than or equal to 2, and an initial dielectric breakdown strength greater than or equal to 20 kV/mm.

2. The insulating heat-conductive sheet according to 1, wherein the dielectric breakdown strength after the sheet is held at 150° C. for 3000 hours is greater than or equal to 30% of the initial dielectric breakdown strength.

3. The insulating heat-conductive sheet according to 1 or 2, wherein the average value of ratios of the thermal conductivity in the thickness direction to the thermal conductivity in the planar direction of the insulating heat-conductive sheet is greater than or equal to 2 and less than or equal to 50.

4. The insulating heat-conductive sheet according to any one of 1 to 3, wherein the average value of tilt angles of the insulating heat-conductive fibers penetrating in the thickness direction relative to the sheet plane is greater than or equal to 60° and less than or equal to 90°.

5. The insulating heat-conductive sheet according to any one of 1 to 4, wherein at least one sheet surface has a surface roughness less than or equal to 15 μm.

6. The insulating heat-conductive sheet according to any one of 1 to 5, wherein the sheet has a durometer hardness less than or equal to the Shore A hardness of 80 and greater than or equal to the Shore E hardness of 5.

7. The insulating heat-conductive sheet according to any one of 1 to 6, being evaluated as V-0 in the UL 94 flame retardance test.

8. The insulating heat-conductive sheet according to any one of 1 to 7, wherein the insulating highly heat-conductive fiber penetrating in the thickness direction is any one of a boron nitride fiber, a high strength polyethylene fiber and a polybenzazole fiber.

9. The insulating heat-conductive sheet according to any one of 1 to 8, wherein the binder resin is any one of a silicone-based resin, an acrylic resin, a urethane-based resin, an EPDM-based resin and a polycarbonate-based resin.

10. The insulating heat-conductive sheet according to any one of 1 to 9, wherein the insulating highly heat-conductive fibers penetrating in the thickness direction have a penetration density greater than or equal to 6% and less than or equal to 50%.

11. An insulating heat-conductive sheet including insulating highly heat-conductive fibers penetrating in a thickness direction of the sheet and a binder resin, wherein the insulating heat-conductive sheet has a ratio of thermal conductivity in the thickness direction to thermal conductivity in a planar direction greater than 12 and less than or equal to 50, the insulating highly heat-conductive fibers penetrating in the thickness direction have a penetration density greater than or equal to 6%, and the insulating heat-conductive sheet has a volume resistivity greater than or equal to 10¹² Ω·cm.

12. The insulating heat-conductive sheet according to 11, wherein the insulating highly heat-conductive fibers penetrating in the thickness direction have a penetration density greater than or equal to 30% and less than or equal to 70%.

13. The insulating heat-conductive sheet according to 11 or 12, wherein the average value of tilt angles of the insulating highly heat-conductive fibers penetrating in the thickness direction relative to the sheet plane is greater than or equal to 60° and less than or equal to 90°.

14. The insulating heat-conductive sheet according to any one of 11 to 13, wherein at least one sheet surface has a surface roughness less than or equal to 15 μm.

15. The insulating heat-conductive sheet according to any one of 11 to 14, being evaluated as V-0 in the UL 94 flame retardance test.

16. The insulating heat-conductive sheet according to any one of 11 to 15, wherein the insulating highly heat-conductive fiber penetrating in the thickness direction is any one of a boron nitride fiber, a high strength polyethylene fiber and a polybenzazole fiber.

17. The insulating heat-conductive sheet according to any one of 11 to 16, wherein the binder resin is any one of a silicone-based resin, an acrylic resin, a urethane-based resin, an EPDM-based resin and a polycarbonate-based resin.

18. A production method of an insulating heat-conductive sheet including the steps of:

subjecting insulating highly heat-conductive fibers to an easy adhesion treatment;

cutting the insulating highly heat-conductive fibers into an arbitrary length to give insulating highly heat-conductive short fibers;

erecting the insulating highly heat-conductive short fibers by electrostatic flocking on a base material coated with an adhesive;

adhering and fixing the erected insulating highly heat-conductive short fibers by heating, preferably shrinking the base material while or after adhering and fixing the erected insulating highly heat-conductive short fibers;

impregnating the erected insulating highly heat-conductive short fibers fixed on the base material with a binder resin and curing the binder resin; and

polishing both surfaces after the short fibers and the binder resin are peeled off from the base material or without peeling off the short fibers and the binder resin from the base material.

19. A production method of an insulating heat-conductive sheet including the steps of:

erecting insulating highly heat-conductive short fibers at a tilt angle of 60° to 90° relative to the sheet plane by electrostatic flocking on a base material coated with an adhesive;

destaticizing the erected insulating highly heat-conductive short fibers;

shrinking the base material at a shrinkage ratio making the penetration density less than or equal to 70% while or after adhering and fixing the erected insulating highly heat-conductive short fibers by heating;

impregnating the erected insulating highly heat-conductive short fibers fixed on the base material with a binder resin and solidifying the binder resin; and

polishing both surfaces after the short fibers and the binder resin are peeled off from the base material or without peeling off the short fibers and the binder resin from the base material.

### Advantageous Effects of Invention

It is made possible by the present invention to release heat quickly from a heat generator such as a semiconductor and an LED to a heat dissipator while ensuring the insulation reliability, and as a result thereof, the damage of a peripheral member caused by heat can be reduced.

### BRIEF DESCRIPTION OF DRAWINGS

FIG. 1 shows an example of the production method of an insulating heat-conductive sheet according to the present invention.

FIG. 2 shows the relationship between the electrostatic flocking condition and the saturated flocking density in the present invention.

FIG. 3 shows an example of a calibration curve of the value of E and the penetration density in the present invention.

FIG. 4 shows the relationship between the charge amount of short fibers and the flocking density in the present invention.

### DESCRIPTION OF EMBODIMENTS

Hereinafter, the present invention will be described in detail. A first aspect of the present application is an insulating heat-conductive sheet including insulating highly heat-conductive fibers penetrating in the thickness direction of the sheet and a binder resin, wherein the insulating highly heat-conductive fibers penetrating in the thickness direction have a penetration density greater than or equal to 6%, and the insulating heat-conductive sheet has a ratio of thermal conductivity in the thickness direction to thermal conductivity in a planar direction greater than or equal to 2, and an initial dielectric breakdown strength greater than or equal to 20 kV/mm.

A second aspect of the present application is an insulating heat-conductive sheet including insulating highly heat-conductive fibers penetrating in a thickness direction of the sheet and a binder resin, wherein the insulating heat-conductive sheet has a ratio of thermal conductivity in the thickness direction to thermal conductivity in a planar direction greater than 12 and less than or equal to 50, the insulating highly heat-conductive fibers penetrating in the thickness direction have a penetration density greater than or equal to 6%, and the insulating heat-conductive sheet has a volume resistivity greater than or equal to 10¹² Ω·cm.

Hereinafter, unless otherwise stated, matters common to the first aspect of the present application and the second aspect of the present application will be described.

It is necessary for the insulating heat-conductive sheet according to the present invention to allow a fibrous insulating highly heat-conductive filler penetrating in the thickness direction of the sheet to be densely oriented and to extend, and it is essential therefor to include a binder resin. With this setup, it is possible to obtain a sheet having electrical insulation properties and being capable of conducting heat selectively in the thickness direction, and heat generated from a heat generator is transported through insulating highly heat-conductive fibers penetrating in the thickness direction to the opposite side face of the sheet to be conducted to a cooling member or a housing.

Moreover, it is necessary for the insulating heat-conductive sheet according to the present invention to allow a face of the sheet to be smooth on at least one side of the sheet. By allowing the face of the sheet to be smooth, insulating highly heat-conductive fibers are closely abutted to a heat generating face and it is possible to efficiently conduct heat. Moreover, in the case where a cooling member or a housing is arranged on a face at the opposite side of the smooth face, in order that the face is closely abutted thereto to efficiently conduct heat, it is also necessary to allow the opposite side face to be smooth.

In the insulating heat-conductive sheet according to the present invention, the ratio of the thermal conductivity in the thickness direction to the thermal conductivity in the planar direction is greater than or equal to 2, preferably greater than or equal to 6, more preferably greater than 12, and further preferably greater than or equal to 20. When the ratio of the thermal conductivity lies within the above-described range, it is possible to conduct heat selectively in the thickness direction and quickly, and since the accumulation of heat within equipment filled therewith can be prevented, heat damage to peripheral equipment can be alleviated. It is good to make the ratio of the thermal conductivity higher, but the upper limit is substantially 50 or so in the procedure of the present invention.

In the first aspect of the present application, it is necessary that the fibers have a penetration density greater than or equal to 6%, it is preferred that the penetration density be greater than or equal to 6% and less than or equal to 50%, and it is more preferred that the penetration density be greater than or equal to 10% and less than or equal to 40%. When the penetration density is less than or equal to 6%, the sheet is not preferred because the thermal conductivity in the sheet thickness direction is low. When the penetration density is greater than or equal to 50%, the sheet is not preferred because the strength of the sheet is low and handling properties are poor.

The penetration density of fibers in the present invention can be evaluated by the method in examples described below.

In the insulating heat-conductive sheet according to the present invention, the volume resistivity is preferably greater than or equal to 10¹⁰ Ω·cm, preferably greater than or equal to 10¹² Ω·cm, and further preferably greater than or equal to 10¹³ Ω·cm. When the volume resistivity is high, the sheet can be suitably used for applications such as peripheral equipment having a power source where high insulation reliability is required. Although the upper limit value of the volume resistivity is not particularly limited, the value is 10¹⁶ Ω·cm or so.

It is preferred that the insulating heat-conductive sheet according to the present invention have an initial dielectric breakdown strength greater than or equal to 20 kV/mm and less than or equal to 70 kV/mm, further preferably greater than or equal to 25 kV/mm. When the dielectric breakdown strength is greater than or equal to 20 kV/mm, an insulating material for ensuring insulation properties does not need to be inserted into electronic equipment to be prepared, resulting in a widened occupied zone of the equipment to be prepared, reduction in weight thereof, and furthermore, reduction in cost.

In the second aspect of the present application, it is necessary that the insulating highly heat-conductive fibers have a penetration density in the sheet thickness direction of greater than or equal to 6%, it is preferred that the penetration density be greater than or equal to 30%, and it is more preferred that the penetration density be greater than or equal to 30% and less than or equal to 70%. When the penetration density is less than or equal to 30%, the difference between thermal conductivities in the sheet planar direction and in the thickness direction is small and the thermal anisotropy is not sufficient. The penetration density is further preferably greater than or equal to 50% and less than or equal to 70%.

The insulation properties are significantly lowered due to the existence of voids in a film. As such, the adhesive properties of the interface between the insulating highly heat-conductive fiber and the binder resin are of great importance. Accordingly, by subjecting the surface of the insulating highly heat-conductive fiber to an easy adhesion treatment, the adhesive properties of the insulating highly heat-conductive fiber to the binder resin are enhanced, and by suppressing interfacial peeling between the two, the insulation properties can be ensured.

However, it is assumed that an electronic part is exposed to environments under various temperature ranges during the production process. It is assumed that the adhesive properties of the insulating highly heat-conductive fiber to the binder resin are lowered depending on various temperature ranges and retention time.

In the case where an insulating heat-conductive sheet is exposed to environments under various temperatures over a certain period of time, it can be said that the sheet has sufficient insulation properties when the dielectric breakdown strength after the sheet is exposed thereto is greater than or equal to 30% of the initial dielectric breakdown strength. Although the treatment temperature and time are not particularly limited, the temperature needs only to lie within the range of an actuation environment temperature of the simulated electronic part to a processing temperature in the production process, and after an insulating heat-conductive sheet is held preferably at 150° C./3000 hours, more preferably at 200° C./3000 hours and further preferably at 300° C./3000 hours, the dielectric breakdown strength of the insulating heat-conductive sheet is greater than or equal to 30%, more preferably greater than or equal to 60% and further preferably greater than or equal to 90%, of the initial dielectric breakdown strength.

In the insulating heat-conductive sheet according to the present invention, it is preferred that the dielectric breakdown strength after the sheet is subjected to the −40° C. to 150° C. thermal shock test repeated 1500 times be greater than or equal to 30% of the initial dielectric breakdown strength. The dielectric breakdown strength is more preferably greater than or equal to 60% thereof and further preferably greater than or equal to 90% thereof.

The insulating highly heat-conductive fiber may have any sectional shape, but a circular shape is preferred because the penetration density is easily heightened. Although the diameter of the circle is not particularly limited, a diameter less than or equal to 1 mm is preferred from the viewpoint of uniformly dissipating heat from an object. The length of the fiber is adjusted according to the thickness of the sheet, and it is essential for the fiber to penetrate in the thickness direction of the sheet.

In the insulating highly heat-conductive fiber of the present invention, it is preferred that the surface thereof be coated with a composition having satisfactory wettability to the binder resin or the fiber surface be subjected to an easy adhesion treatment such as an electron beam treatment. As the electron beam treatment, an electron beam technique such as a plasma treatment, a corona treatment, a high-frequency sputter etching treatment and an ion beam treatment can be utilized. By improving the adhesive properties of the fiber surface to the binder resin by means of these treatments, even in the case where the flexibility of the binder resin is impaired by being used at a high temperature or the case where thermal stress is applied to the fiber-resin interface due to a change in temperature, the interfacial peeling becomes difficult to occur.

As a method of making the insulating highly heat-conductive fiber of the present invention easily adherable, an electron beam treatment is more preferred from the viewpoints of productivity and handling convenience, and in particular, an ion beam treatment having a high effect of making the fiber easily adherable is suitably used. In the case where a plasma treatment, a high-frequency sputter etching treatment or the like is used, a protrusion itself is cut and a high anchor effect is hardly attained when the irradiation time is prolonged and the irradiation energy is heightened, but in an ion beam treatment, protrusions having a large difference in height and crack-like recesses are formed and a high anchor effect is attained. While the reason why the above-described recesses and protrusions are formed has not yet been elucidated, it is presumed that protrusions having a large difference in height are effectively obtained since an ion beam has directivity in the ionic velocity.

In order to subject the fiber to an ion beam treatment, a method of unwinding a fiber after spinning or a heat treatment by a roll-to-roll process and continuously subjecting the fiber to roll-to-roll processing with an ion beam treatment apparatus and a batch processing method can be employed, but from the viewpoint of runnability, a roll-to-roll process is preferred. In addition to a fiber bundle, the object to be treated may be fibers prepared by separating a fiber bundle into single fibers and aligning the fibers in one direction or a woven fabric. As an ion gun for irradiating the fiber with an ion beam, for example, a closed drift ion source available from Kaufman & Robinson (KRI) can be utilized, and as an ion source, DC discharge, RF discharge, microwave discharge or the like can be utilized. In particular, it is preferred that a linear ion source be used in the roll-to-roll processing.

Any gas can be used without limitation as the gas used for the ion gun as long as the gas is capable of forming ion particles, and for example, the gas is appropriately selected from among hydrogen, helium, oxygen, nitrogen, air, fluorine, neon, argon, krypton, N₂O and a mixed gas thereof to be used. Of these, in particular, oxygen and air are preferred because the above-described protrusions are formed on the fiber surface, and at the same time, the fiber surface can be imparted with functional groups.

The energy of ion particles constituting the ion beam is adjusted to 10⁻² to 10⁰ KeV or so by appropriately selecting the discharge voltage, discharge current, discharge power, beam gas flow rate and the like of the ion gun, and it is preferred that the discharge voltage and the discharge current be adjusted to 295 to 800 W or so and 0.1 to 10 A or so respectively to perform the irradiation. It is preferred that the pressure at the time of the treatment be adjusted to 0.1 to 1.0 Pa or so and the fiber feeding speed be adjusted to 0.01 to 1.0 m/min, preferably 0.01 to 0.3 m/min, to perform the irradiation.

It is preferred that the flame retardancy of the insulating heat-conductive sheet according to the present invention correspond to V-0. When the flame retardancy corresponds to V-0, the spread of fire can be alleviated even if electronic equipment ignites due to a short circuit or deterioration of a circuit, and the like.

The thickness of the sheet is preferably greater than or equal to 10 μm and less than or equal to 300 μm and more preferably greater than or equal to 50 μm and less than or equal to 80 μm. When the thickness is less than 10 μm, the sheet is not preferred because the strength of sheet is low and handling properties are poor. Moreover, when the thickness is greater than 300 μm, the sheet is not preferred because the thermal resistance is large.

It is preferred that the average surface roughness of the sheet be less than or equal to 15 μm. When the average surface roughness is greater than or equal to 15 μm, the heat conductivity is low since the abutting property to a heat generator or a heat dissipator is impaired.

It is preferred that the durometer hardness of an insulating highly heat-conductive sheet in the present invention be less than or equal to the Shore A hardness of 80 and greater than or equal to the Shore E hardness of 5, and the durometer hardness is more preferably less than or equal to the Shore A hardness of 70 and greater than or equal to the Shore E hardness of 10. When the Shore A hardness is low, the sheet can be closely abutted to a heat generator or a heat dissipator along minute recesses and protrusions thereof and it is possible to efficiently conduct heat. On the other hand, when the Shore E hardness is high, handling properties at the time the sheet is assembled into electronic equipment or a light source is satisfactory.

The insulating highly heat-conductive fiber in the present invention is not particularly limited as long as the fiber has electrical insulation properties and high heat conductivity, and examples thereof include a boron nitride fiber, a high strength polyethylene fiber, a polybenzazole fiber and the like. In particular, a polybenzazole fiber also having heat resistance and being easily available is preferred. Since a carbon fiber has high heat conductivity but also has electric conductivity, the carbon fiber is not suitable for use in the present invention from the viewpoint of electrical insulation properties. As the polybenzazole fiber, it is possible to purchase a commercial product thereof (Zylon available from TOYOBO CO., LTD.).

The thermal conductivity of the insulating highly heat-conductive fiber is preferably greater than or equal to 20 W/mK and more preferably greater than or equal to 30 W/mK. When the thermal conductivity is greater than or equal to 20 W/mK, high heat conductivity is attained at the time the fiber is formed into a sheet.

It is preferred that the binder resin be excellent in heat resistance, electrical insulation properties and thermal stability, and by properly selecting the binder resin, it is possible to adjust these physical properties within a desired range. It is preferred that a resin excellent in flexibility or a resin having adhesive properties be selected in view of the abutting property to a heat generator. Examples of the material excellent in flexibility include a silicone-based resin, an acrylic resin, a urethane-based resin, EPDM and a polycarbonate-based resin, and examples of the material having adhesive properties include a thermoplastic resin and a thermosetting resin in a semi-cured state. As the material excellent in flexibility, in particular, a silicone-based resin which has little change in physical properties by a heat cycle and hardly deteriorates is preferred. As the material having adhesive properties, a urethane-based resin satisfactory in shock absorbing properties is preferred from the viewpoint of thermal shock resistance at an abutting face to a heat generator. Moreover, by selecting a flame-retardant material, it is possible to impart a heat-conductive sheet with flame retardance.

An adhesive may be applied to the surface of the sheet of the present invention. Although the adhesive is not particularly limited, examples thereof include an acrylic acid ester resin, an epoxy resin, a silicone resin or the like, and a resin prepared by mixing these resins with a highly heat-conductive filler such as a metal, a ceramic and graphite.

The volume resistivity of the insulating highly heat-conductive fiber and the binder resin is greater than or equal to 10¹⁰ Ω·cm, preferably greater than or equal to 10¹² Ω·cm, and further preferably 10¹³ Ω·cm. When the volume resistivity lies within this range and there is no interfacial peeling between the fiber and the binder resin, it is possible to maintain a high dielectric breakdown strength under a practical use environment.

An insulating highly heat-conductive sheet according to the first aspect of the present application can be produced by a method including the following steps.

(i) The step of coating the insulating highly heat-conductive fiber with a resin different from the binder resin or subjecting the insulating highly heat-conductive fiber to electron beam irradiation.

(ii) The step of cutting the insulating highly heat-conductive fiber into an arbitrary length to give insulating highly heat-conductive short fibers.

(iii) The step of erecting the insulating highly heat-conductive short fibers by electrostatic flocking on a base material coated with an adhesive.

(iv) The step of adhering and fixing the erected insulating highly heat-conductive short fibers by heating, preferably shrinking the base material while or after adhering and fixing the erected insulating highly heat-conductive short fibers.

(v) The step of impregnating the erected insulating highly heat-conductive short fibers fixed on the base material with a binder resin and curing the binder resin.

(vi) The step of polishing both surfaces after the short fibers and the binder resin are peeled off from the base material or without peeling off the short fibers and the binder resin from the base material.

An insulating highly heat-conductive sheet according to the second aspect of the present application can be suitably produced by a method including the following steps.

(i) The step of erecting insulating highly heat-conductive short fibers at a tilt angle of 60° to 90° relative to the sheet plane by electrostatic flocking on a base material coated with an adhesive;

(ii) the step of destaticizing the erected insulating highly heat-conductive short fibers;

(iii) the step of shrinking the base material at a shrinkage ratio making the penetration density less than or equal to 70% while or after adhering and fixing the erected insulating highly heat-conductive short fibers by heating;

(iv) the step of impregnating the erected insulating highly heat-conductive short fibers fixed on the base material with a binder resin and solidifying the binder resin; and

(v) the step of polishing both surfaces after the short fibers and the binder resin are peeled off from the base material or without peeling off the short fibers and the binder resin from the base material.

The electrostatic flocking refers to a technique of arranging a base material at one of two electrodes and a short fiber at the other thereof, electrically charging the short fibers by applying high voltage thereto, and casting and anchoring the short fibers to the base material side to be fixed by an adhesive.

In the present invention, allowing flocked fibers to be firmly erected is an important point to allow the insulating heat-conductive sheet to exhibit high thermal anisotropy. The average value of tilt angles of insulating highly heat-conductive fibers after electrostatic flocking relative to the sheet plane in the above-described production process is greater than or equal to 60° and less than or equal to 90°, preferably greater than or equal to 65° and less than or equal to 90°, and further preferably greater than or equal to 70° and less than or equal to 90°. By controlling the tilt angles within this range, the collision frequency between fibers is decreased in the subsequent shrinking step, and it is possible to shrink the base material without generating wrinkles and flexure. Moreover, it is also possible to maintain the above-mentioned tilt angles after shrinkage, and high thermal anisotropy can be ensured at the time the fiber is formed into a sheet.

It is preferred that the electrostatic flocking in the present invention be performed by an electrostatic flocking method in which firmly erected fibers are obtained, and an upward flocking method is preferred. In a downward flocking method, since short fibers naturally falling by gravity are flocked in addition to short fibers attracted to the counter electrode along the line of electric force by electrostatic attraction, the fibers are poorly erected. On the other hand, in an upward flocking method, since only short fibers attracted by electrostatic attraction are flocked, the fibers are satisfactorily erected.

In order to obtain firmly erected fibers, it is preferred that the electric field intensity E, which is a mathematical product of the distance r (cm) between electrodes and the applied voltage V (kV) at the time of electrostatic flocking, satisfy the following equation 1, and the quotient a of the fineness (D) divided by the fiber length (mm) of the insulating highly heat-conductive fiber satisfy the following equation 2. When the value of E is less than or equal to the lower limit of the range of the equation 1, the electric field intensity is insufficient and sufficiently erected fibers are not obtained. When the value of E is greater than or equal to 8, dielectric breakdown occurs and electrostatic flocking cannot be normally performed. When the value of a is less than or equal to 1.5, the aspect ratio of the fiber is large and it is difficult to erect the fibers due to their own weight. When the value of a is greater than or equal to 10.2, the aspect ratio is small and the fibers are poorly erected since the polarizability in the fiber axis direction within the fiber is small.

0.25a+3.37≦E≦8 Equation 1

(r: distance between electrodes (cm), V: applied voltage (kV), E=V/r)

2≦a≦10 Equation 2

(a: fineness (D)/fiber length (mm))

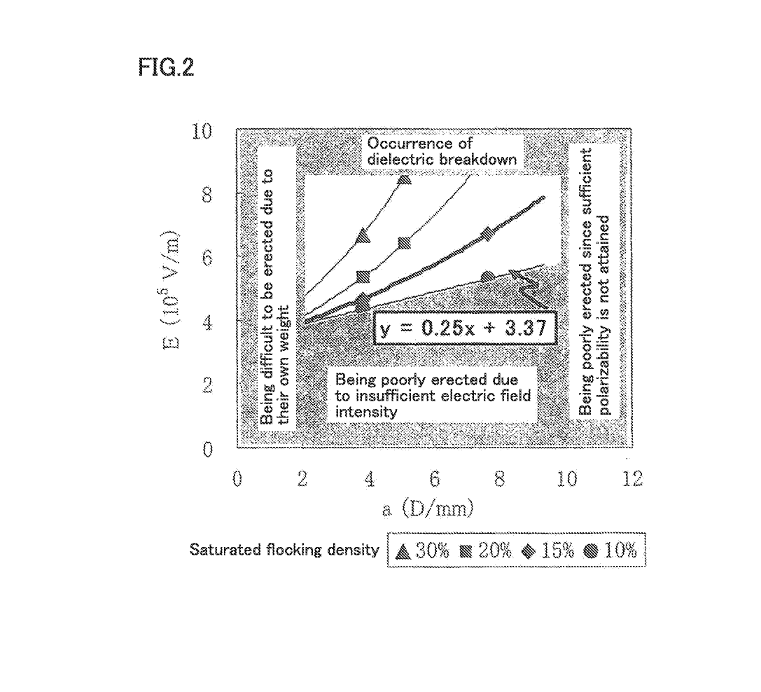

The above-mentioned preferred production condition is shown in FIG. 2. By performing electrostatic flocking under the condition lying within the above-described range, it is possible to allow tilt angles of insulating highly heat-conductive fibers relative to the sheet plane to be greater than or equal to 60°. In the first aspect of the present application, by performing electrostatic flocking under the condition lying within the above-described range, it is possible to allow the insulating highly heat-conductive fibers to have a final penetration density of 30%.

In the second aspect of the present application, it is preferred that the flocking density and the shrinkage ratio of the base material be adjusted respectively so that the penetration density of fibers at the time the fibers are formed into a sheet after shrinkage would be greater than or equal to 30% and less than or equal to 70%. When the penetration density after shrinkage is too high, electrostatic repulsion by residual electric charge and physical repulsion are large, and wrinkles and flexure are easily generated at the time of shrinkage. The area shrinkage ratio of the base material is not particularly limited, but for example, when the heat shrinkage ratio in at least one direction of a base material immersed in 95° C. hot water for 10 seconds lies within the range of 30 to 85%, it is possible to shrink the base material with satisfactory quality.

Moreover, with regard to the shrinkage direction, either of a biaxially shrinked base material and a monoaxially shrinked base material is acceptable. A monoaxially shrinked base material is preferred in view of ease of continuous production, but in the case where the penetration density after shrinkage is set to a high level, it is preferred that a biaxially shrinked base material in which wrinkles and flexure are more hardly generated be used.

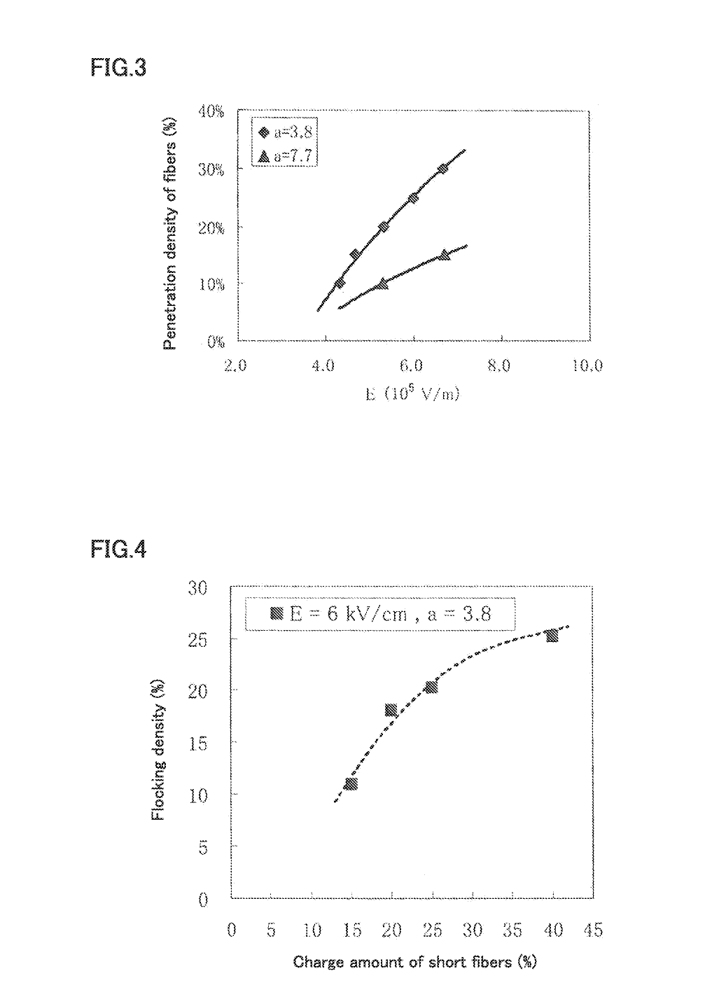

As shown in FIG. 2, the flocking density, namely the penetration density of fibers, can be controlled by adjusting the applied voltage and the distance between electrodes at the time of electrostatic flocking to determine an appropriate value of E. As shown in FIG. 3, a calibration curve of the value of E and the penetration density of fibers is prepared in advance, and electrostatic flocking can be performed with a value of E suitable for a desired penetration density to control the flocking density. Alternatively, as shown in FIG. 4, also by adjusting the charge amount of short fibers arranged on the electrode, the flocking density can be controlled. The charge amount refers to a theoretical penetration density in the case where all short fibers arranged on the electrode are flocked.

The material of an adhesive used in the above-mentioned step is not particularly limited since the adhesive can be removed in the subsequent polishing step, but an adhesive low in electric insulation resistance is preferred in view of satisfactory erection of the fibers. For example, an aqueous dispersion of an acrylic resin and the like is suitably used. Moreover, a small coating thickness of the adhesive is preferred in order to suppress the insulation resistance low. However, it is necessary to make the coating thickness large to such an extent that fibers cast and anchored can be fixed, and the coating thickness is preferably greater than or equal to 10 μm and less than or equal to 50 μm and more preferably greater than or equal to 10 μm and less than or equal to 30 μm.

The destaticization in the above-mentioned step can be carried out by bringing an earth terminal into contact with the flocked sheet to remove residual electric charge or by removing static electricity with an ionizer.

As a base material used in the first aspect of the present application, for the purpose of attaining a high flocking density at the time of electrostatic flocking, a material small in insulation resistance is preferred in order to heighten the electrostatic attraction. Moreover, for the purpose of reducing the cost, it is preferred that a material from which a sheet is peelable after the binder is solidified be selected, and for example, a sheet of metal foil, a polyethylene terephthalate film coated with a conductive agent or a graphite sheet can be used. Moreover, in the case of shrinking the base material in the subsequent step, it is necessary to use a shrinkable film, and for example, it is possible to use a shrinkable polystyrene or polyethylene terephthalate film coated with a conductive agent.

With regard to a base material used in the second aspect of the present application, it is preferred that a material shrinkable by heating or the like be used. For example, it is possible to use a heat-shrinkable polystyrene or polyester film. Moreover, a material low in insulation resistance is preferred in order to obtain firmly erected fibers, and it is preferred that the thickness of the base material be less than or equal to 50 μm or the base material be coated with a conductive material.

In the production process of the present invention, the step of impregnating the erected insulating highly heat-conductive fibers fixed on the base material with a binder resin and solidifying the binder resin can be performed by any one of methods described below. (i) A method of impregnating the fibers with a binder resin in a state of being dissolved in any solvent or being an emulsion and volatilizing the solvent by heating to solidify the binder resin, (ii) a method of impregnating the fibers with a binder resin in a state of being melted by heating and solidifying the binder resin by cooling, and (iii) a method of impregnating the fibers with monomers for a binder resin and solidifying the monomers by heating or an energy ray such as an ultraviolet ray, an infrared ray and an electron beam.

For the polishing in the present invention, a grinding machine, an abrasive machine, a lapping machine, a polishing machine, a honing machine, a buffing machine, a CMP apparatus and the like can be used. It is possible to produce an insulating heat-conductive sheet by polishing a sheet after the fiber and the binder resin are peeled off from the base material or by polishing a sheet together with the base material. The surface roughness of the smooth face can be controlled by the granularity of the polishing grindstone or the abrasive paper. Although the appropriate granularity varies with the material of the binder resin and the highly heat-conductive fiber to be used, the smoothness is enhanced when the granularity is lowered. For example, in the case where a polybenzazole fiber is used as the insulating highly heat-conductive fiber and a silicone resin with a hardness of Shore A 65 is used as the binder resin, a smooth face with a surface roughness of 10 μm or so is obtained when the granularity is greater than or equal to #2000, and moreover, a smooth face with a surface roughness of 5 μm or so is obtained when the granularity is #660.

### EXAMPLES

The durability test in the present invention was carried out by the following method.

The high-temperature holding test was performed by allowing a test specimen to settle for 3000 hours in an air blowing constant-temperature dryer (DRX620DA available from Advantec Toyo Kaisha, Ltd.) adjusted to a test temperature.

The thermal shock test was performed by exposing a test specimen alternately to −40° C. and 150° C. environments for a period of holding time of 15 minutes using a compact thermal shock chamber (TSE-11-A available from ESPEC CORP.).

The evaluation methods for various physical properties in the present invention are as follows.

The fineness of the insulating highly heat-conductive fiber was calculated according to the following calculation formula by cutting a 10-cm portion of a long fiber bundle to obtain a test specimen and measuring the weight of the test specimen using an ultramicro balance (ME5 available from Sartorius Japan K.K.).

Fineness (denier)=weight (g)×90000

The fiber diameter of the insulating highly heat-conductive fiber was defined as an average value of the fiber diameters at the center point in the fiber length direction of 100 test specimens obtained when short fiber test specimens were observed with a microscope.

The thermal conductivity in the fiber axis direction of the insulating highly heat-conductive fiber was measured by a steady heat flow method using a system having a temperature control unit with a helium refrigerator. Moreover, the length of a sample fiber was set to about 25 mm, and about 1000 single fibers were arranged and bundled as a fiber bundle. Then, both ends of the sample fibers were fixed by the Stycast GT and the fiber bundle was set on a sample stage. For the temperature measurement, an Au-chromel thermocouple was used. For the heater, 1-kΩ electrical resistance was used and this was bonded to the fiber bundle end with varnish. The measurement temperature region was set to 27° C. The measurement was performed under vacuum of 10⁻³ Pa for securing heat insulating properties. The measurement was started at the end of 24 hours after the atmosphere was kept at a vacuum state of 10⁻³ Pa for the purpose of ensuring the dry state.

The measurement of the thermal conductivity was performed by allowing a constant current to flow through the heater so that the temperature difference ΔT between two points separated by a distance L becomes 1 K. This is shown in FIG. 2. In this context, when the cross sectional area of the fiber bundle, the distance between two thermocouples, the quantity of heat given by the heater and the temperature difference between the two thermocouples are defined as S, L, Q and ΔT respectively, the thermal conductivity λ to be determined can be calculated according to the following calculation formula. Examples measured by means of the method of the present experiment will be described below.

λ (W/mK)=(Q/ΔT)×(L/S)

The volume resistivity of the insulating highly heat-conductive fiber was measured by the following method.

A long fiber bundle was dried for 1 hour at 105° C., after which the long fiber bundle was allowed to stand for 24 hours or more in an atmosphere of 25° C. and 30 RH % to be moisture-controlled. While being separated by an interval of respective constant lengths (5 cm, 10 cm, 15 cm, 20 cm), a positive electrode and an earth electrode were brought into contact with the long fiber bundle, and a voltage of 10 V was applied between both electrodes to measure a resistance value (Ω) with a digital multimeter (R6441 available from ADVANTEST CORPORATION). From this resistance value, volume resistivity values at respective lengths of intervals were determined according to the following calculation formula, and an average value thereof was defined as the volume resistivity value of the sample.

ρ=R×(S/L)

ρ, R, S and L represent the volume resistivity (Ωcm), the resistance value (Ω) of a test specimen, the cross sectional area (cm²) and the length (2 cm), respectively. In this connection, the cross sectional area of the test specimen was calculated by observing the fibers with a microscope.

The volume resistivity of a binder resin was measured in an atmosphere of 25° C. and 60 RH % using a high-resistance resistivity meter HIRESTA-IP (available from Mitsubishi Petrochemical Corporation) by allowing a sheet prepared by solution film formation or melt film formation from the binder resin to be moisture-controlled for 24 hours or more in an atmosphere of 25° C. and 60 RH %. Applied voltages were switched in the order of 10 V, 100 V, 250 V and 500 V until the applied voltage reached a voltage at which the measurement value was stabilized to perform the measurement. The measurement range was automatically set. A value obtained after the measurement value is stabilized was defined as the volume resistivity.

The volume resistivity of a sheet was measured in an atmosphere of 25° C. and 60 RH % using a high-resistance resistivity meter HIRESTA-IP (available from Mitsubishi Petrochemical Corporation) by allowing the sheet to be moisture-controlled for 24 hours or more in an atmosphere of 25° C. and 60 RH %. Applied voltages were switched in the order of 10 V, 100 V, 250 V and 500 V until the applied voltage reached a voltage at which the measurement value was stabilized to perform the measurement. The measurement range was automatically set. A value obtained after the measurement value is stabilized was defined as the volume resistivity.

The density of a sheet and fibers was measured by means of a dry type automatic density meter (AccuPyc II 1340 available from SHIMADZU CORPORATION).

The average surface roughness of a sheet was measured by means of a surface roughness shape measuring machine (Softest SV-600 available from Mitutoyo Corporation) under conditions of a measurement width of 5 mm and a stylus moving speed of 1.0 mm/s.

The hardness of a sheet was measured in accordance with JIS K 6253.

The dielectric breakdown strength of a sheet was measured in accordance with ASTM D 149, and the measurement was performed by a short time method using TP-516UZ (available from TAMADENSOKU CO., LTD.). As the sheet, a sheet moisture-controlled for 48 hours at 23±2° C. and 50±5% RH was used. The sheet was sandwiched between a lower electrode with a φ6-mm circular column shape and an upper electrode with a φ25-mm circular column shape, a voltage was applied at a voltage increasing rate of 0.1 to 0.2 kV/s to the sheet in the atmosphere of 23±2° C. and 50±5% RH, and a voltage value at which dielectric breakdown occurred was measured. An average value of measured values at nine arbitrary points in the φ80-mm sheet was defined as the dielectric breakdown strength of the sheet.

Each of the thermal conductivities in the sheet thickness direction and the sheet planar direction was determined according to the following calculation formula using each of the thermal diffusivities in the sheet thickness direction and the sheet planar direction, the specific heat of the sheet and the density of the sheet. The thermal diffusivity was measured using a thermophysical property measuring apparatus Thermowave Analyzer TA3 available from BETHEL Co., Ltd.

λ=α×Cp×ρ Equation 4

(λ: thermal conductivity (W/mK), α: thermal diffusivity (m²/s), Cp: specific heat (J/gK), ρ: density (g/m³))

The ratio of the thermal conductivity in the thickness direction to the thermal conductivity in the planar direction of a sheet was calculated from the following equation using respective average values of the thermal conductivity in the thickness direction and planar direction of the sheet measured at five arbitrary points.

Ratio of thermal conductivity in thickness direction to thermal conductivity in planar direction of sheet=(average value of thermal conductivity in thickness direction)/(average value of thermal conductivity in planar direction)

The penetration density of insulating highly heat-conductive fibers in the sheet was evaluated by the following method.

(i) An identical coordinate position of each of both surfaces of a sheet is positioned at the center of visual field, and each of both surfaces is photographed through a lens of 20 magnifications with an epifluorescent optical microscope.

(ii) The number of fiber sections in a photographed image of each surface is counted.

(iii) The volume content rate of fibers in each surface is calculated according to the following calculation formula.

Volume content rate of fibers in each surface=[(number of fiber sections in photographed image)×(fiber cross sectional area calculated from fiber diameter)]/(area of observation visual field)

(iv) A smaller value among volume content rates of fibers of respective surfaces was defined as the volume content rate of penetrating fibers, namely the penetration density.

Moreover, a flocked sheet was embedded in an epoxy resin, the cross section polished in the planar direction was photographed by a microscope, and the flocking density was calculated in the same counting manner as above.

The tilt angles of insulating highly heat-conductive fibers were evaluated by the following method.

(i) A flocked sheet is embedded in an epoxy resin and the resin lump is polished to expose a cross section in the thickness direction of the sheet.

(ii) The cross section in the thickness direction of the sheet is photographed through a lens of 20 magnifications with an epifluorescent optical microscope.

(iii) One hundred fibers are selected and smaller angles among angles in the fiber length direction relative to the smooth face are measured.

(iv) Measured values of the angles are averaged to determine the average value of tilt angles.

Specific examples will be described below. Moreover, the measurement results are summarized in Tables 1 to 3.

### Example 1

The thermal conductivity in the fiber axis direction of Zylon HM (available from TOYOBO CO., LTD.) was determined to be 40 W/mK. As the insulating highly heat-conductive fiber, the Zylon HM cut into a length of 400 μm was used, and as a binder resin liquid, a resin liquid prepared by mixing 100 parts by mass of a liquid silicone rubber main agent TSE3431-A available from Momentive Performance Materials Inc. and 30 parts by mass of a liquid silicone rubber curing agent TSE3431-C available from Momentive Performance Materials Inc. was used. As an adhesive, an aqueous 10 wt. % solution of polyvinyl alcohol AH-26 (available from The Nippon Synthetic Chemical Industry Co., Ltd.) was used. As a base material, SPACECLEAN^{&reg;} S7200 with a thickness of 20 μm was used. The base material was arranged on a positive electrode plate coated thinly with paraffin oil as a lubricant, and a layer of the adhesive with a thickness of 25 μm was applied thereonto. This surface was subjected to electrostatic flocking for 5 minutes under conditions of a distance between electrodes of 3 cm and a voltage of 18 kV to prepare a Zylon flocked sheet. The Zylon charge amount was set to 25%. The positive electrode plate on which the flocked sheet is mounted was destaticized by being connected to the ground, after which the flocked sheet was heated on a 95° C. hot plate to shrink the base material. After the completion of shrinkage, the adhesive was heated for 10 minutes at 80° C. to be solidified. Onto the flocked sheet, a layer of the binder resin liquid with a thickness of 600 μm was applied, defoamed under vacuum, and heated for 1 hour at 80° C. to be solidified. The base material was peeled off from the obtained sheet, and both faces of the sheet were polished with abrasive paper of #2000 granularity to prepare a Zylon composite silicone rubber sheet with a thickness of 100 μm. The volume resistivity of the sheet was determined to be greater than or equal to 10¹⁶ Ω·cm (measuring machine over range). The sheet was evaluated as V-0 in the UL 94 flame retardance test.

### Example 2

Electrostatic flocking and base material shrinkage were performed in the same manner as that in Example 1 except that the Zylon charge amount was set to 20%. As a binder resin liquid, a liquid prepared by mixing 80.9 parts by weight of a saturated copolymerized polyester urethane solution UR3600 available from TOYOBO CO., LTD., 12.0 parts by weight of a saturated copolymerized polyester urethane solution BX-10SS available from TOYOBO CO., LTD., 7.1 parts by weight of an epoxy resin AH-120 available from TOYOBO CO., LTD. and 100 parts by weight of methyl ethyl ketone was used. The sheet after shrinkage was immersed in a binder resin liquid layer with a depth of 1200 μm, defoamed under vacuum, and impregnated with the binder resin liquid. The sheet was dried for 2 hours at 60° C., after which both faces of the sheet were polished with abrasive paper of #2000 granularity to prepare a Zylon composite ester urethane resin sheet with a thickness of 100 μm. In this connection, just after the preparation, the sheet is in a semi-cured state. At the time of practical use, since the sheet in a semi-cured state is bonded to a heat generator or a cooling body, and heated for 4 hours at 140° C. to be completely cured, the sheet in a completely-cured state was measured for the volume resistivity. The volume resistivity of the completely cured sheet was determined to be greater than or equal to 10¹⁶ Ω·cm (measuring machine over range).

### Example 3

A sheet was prepared in the same manner as that in Example 2 except that the voltage at the time of electrostatic flocking was set to 13 kV and the Zylon charge amount was set to 17%. The volume resistivity of the completely cured sheet was determined to be greater than or equal to 10¹⁶ Ω·cm (measuring machine over range).

### Example 4

A sheet was prepared in the same manner as that in Example 2 except that the adhesive coating thickness was set to 50 μm and the Zylon charge amount was set to 30%. The volume resistivity of the completely cured sheet was determined to be greater than or equal to 10¹⁶ Ω·cm (measuring machine over range).

### Example 5

A sheet was prepared in the same manner as that in Example 2 except that the voltage at the time of electrostatic flocking was set to 36 kV, the distance between electrodes was set to 6 cm and the Zylon charge amount was set to 25%. The volume resistivity of the completely cured sheet was determined to be greater than or equal to 10¹⁶ Ω·cm (measuring machine over range).

### Example 6

A sheet was prepared in the same manner as that in Example 1 except that the granularity of the abrasive paper was set to #600. The volume resistivity of the sheet was determined to be greater than or equal to 10¹⁶ Ω·cm (measuring machine over range).

### Example 7

The thermal conductivity in the fiber axis direction of Zylon HM (available from TOYOBO CO., LTD.) was determined to be 40 W/mK. As an ion gun, 38CMLIS available from Advanced Energy Industries, Inc. was used, as a gas introduced into the ion gun, oxygen was used, and the fiber was irradiated with an ion beam from the beam source positioned at a distance of 4 cm from the fiber under conditions of a discharge voltage of 540 V, a discharge current of 0.56 A, a discharge power of 295 W, a beam gas flow rate of 45 sccm and a treatment pressure of 3×10⁻¹ Pa, after which the fiber was cut into a length of 400 μm with a guillotine type cutting machine. As a binder resin liquid, a resin liquid prepared by mixing 100 parts by mass of a liquid silicone rubber main agent TSE3431-A available from Momentive Performance Materials Inc. and 30 parts by mass of a liquid silicone rubber curing agent TSE3431-C available from Momentive Performance Materials Inc. was used. As an adhesive, an aqueous 10 wt. % solution of polyvinyl alcohol AH-26 (available from The Nippon Synthetic Chemical Industry Co., Ltd.) was used. As a base material, a sheet of aluminum foil with a thickness of 11 μm was used. The base material was arranged on a positive electrode plate, and a layer of the adhesive with a thickness of 25 μm was applied thereonto. This surface was subjected to electrostatic flocking for 5 minutes under conditions of a distance between electrodes of 3 cm and a voltage of 18 kV to prepare a Zylon flocked sheet. The obtained flocked sheet was heated for 1 hour at 80° C. to cure the adhesive, after which onto the flocked sheet, a layer of the binder resin liquid with a thickness of 600 μm was applied, defoamed under vacuum, and heated for 1 hour at 80° C. to be solidified. The base material was peeled off from the obtained sheet, and both faces of the sheet were polished with abrasive paper of #2000 granularity to finally prepare a Zylon composite silicone rubber sheet with a thickness of 100 μm. The Shore A hardness of the sheet was determined to be 68. The sheet was evaluated as V-0 in the UL 94 flame retardance test.

### Example 8

As a binder resin liquid, a liquid prepared by mixing 80.9 parts by weight of a saturated copolymerized polyester urethane solution UR3600 available from TOYOBO CO., LTD., 12.0 parts by weight of a saturated copolymerized polyester urethane solution BX-10SS available from TOYOBO CO., LTD., 7.1 parts by weight of an epoxy resin AH-120 and 100 parts by weight of methyl ethyl ketone was used. A flocked sheet prepared in the same manner as that in Example 1 was immersed in a binder resin liquid layer with a depth of 1200 μm, defoamed under vacuum, and impregnated with the binder resin liquid. The sheet was dried for 2 hours at 60° C., after which both faces of the sheet were polished with abrasive paper of #2000 granularity to prepare a Zylon composite ester urethane resin sheet with a thickness of 100 μm. In this connection, just after the preparation, the sheet is in a semi-cured state. At the time of practical use, since the sheet in a semi-cured state is bonded to a heat generator or a cooling body, and heated for 4 hours at 140° C. to be completely cured, the sheet in a completely-cured state was used for the durability test.

### Example 9

A Zylon composite ester urethane resin sheet and a completely cured sheet were prepared by the same procedure as that in Example 8 except that as a binder resin liquid, a liquid prepared by mixing 100 parts by weight of a saturated copolymerized polyester urethane solution UR3575 available from TOYOBO CO., LTD. and 2.4 parts by weight of an epoxy resin HY-30 available from TOYOBO CO., LTD. was used.

### Example 10

A Zylon composite acrylic resin sheet was prepared by the same procedure as that in Example 7 except that as a binder resin liquid, Yodosol AA76 (available from Henkel Japan Ltd.) which is an aqueous dispersion of an acrylic resin was used, and the heating for curing was performed for 1 hour at 80° C.

### Example 11

A Zylon composite ester urethane resin sheet and a completely cured sheet were prepared by the same procedure as that in Example 8 except that the adhesive coating thickness was set to 50 μm.

### Example 12

The thermal conductivity in the fiber axis direction of Zylon HM (available from TOYOBO CO., LTD.) was determined to be 40 W/mK. As an ion gun, 38CMLIS available from Advanced Energy Industries, Inc. was used, as a gas introduced into the ion gun, oxygen was used, and the fiber was irradiated with an ion beam from the beam source positioned at a distance of 4 cm from the fiber under conditions of a discharge voltage of 540 V, a discharge current of 0.56 A, a discharge power of 295 W, a beam gas flow rate of 45 sccm and a treatment pressure of 3×10⁻¹ Pa, after which the fiber was cut into a length of 400 μm with a guillotine type cutting machine. As a binder resin liquid, a resin liquid prepared by mixing 100 parts by mass of a liquid silicone rubber main agent TSE3431-A available from Momentive Performance Materials Inc. and 30 parts by mass of a liquid silicone rubber curing agent TSE3431-C available from Momentive Performance Materials Inc. was used. As an adhesive, an aqueous 10 wt. % solution of polyvinyl alcohol AH-26 (available from The Nippon Synthetic Chemical Industry Co., Ltd.) was used. As a base material, SPACECLEAN^{&reg;} S7200 with a thickness of 20 μm was used. The base material was arranged on a positive electrode plate coated thinly with paraffin oil as a lubricant, and a layer of the adhesive with a thickness of 25 μm was applied thereonto. This surface was subjected to electrostatic flocking for 5 minutes under conditions of a distance between electrodes of 3 cm and a voltage of 18 kV to prepare a Zylon flocked sheet. The Zylon charge amount was set to 25%. The positive electrode plate on which the flocked sheet is mounted was destaticized by being connected to the ground, after which the flocked sheet was heated on a 95° C. hot plate to shrink the base material. After the completion of shrinkage, the adhesive was heated for 10 minutes at 80° C. to be solidified. Onto the flocked sheet, a layer of the binder resin liquid with a thickness of 600 μm was applied, defoamed under vacuum, and heated for 1 hour at 80° C. to be solidified. The base material was peeled off from the obtained sheet, and both faces of the sheet were polished with abrasive paper of #2000 granularity to prepare a Zylon composite silicone rubber sheet with a thickness of 100 μm. The volume resistivity of the sheet was determined to be greater than or equal to 10¹⁶ Ω·cm (measuring machine over range), and the Shore A hardness of the sheet was determined to be 68. The sheet was evaluated as V-0 in the UL 94 flame retardance test.

### Example 13

Electrostatic flocking and base material shrinkage were performed in the same manner as that in Example 1 except that the Zylon charge amount was set to 20%. As a binder resin liquid, a liquid prepared by mixing 80.9 parts by weight of a saturated copolymerized polyester urethane solution UR3600 available from TOYOBO CO., LTD., 12.0 parts by weight of a saturated copolymerized polyester urethane solution BX-10SS available from TOYOBO CO., LTD., 7.1 parts by weight of an epoxy resin AH-120 available from TOYOBO CO., LTD. and 100 parts by weight of methyl ethyl ketone was used. The sheet after shrinkage was immersed in a binder resin liquid layer with a depth of 1200 μm, defoamed under vacuum, and impregnated with the binder resin liquid. The sheet was dried for 2 hours at 60° C., after which both faces of the sheet were polished with abrasive paper of #2000 granularity to prepare a Zylon composite ester urethane resin sheet with a thickness of 100 μm. In this connection, just after the preparation, the sheet is in a semi-cured state. At the time of practical use, since the sheet in a semi-cured state is bonded to a heat generator or a cooling body, and heated for 4 hours at 140° C. to be completely cured, the sheet in a completely-cured state was measured for the volume resistivity and used for the durability test. The volume resistivity of the completely cured sheet was determined to be greater than or equal to 10¹⁶ Ω·cm (measuring machine over range).

### Example 14

Electrostatic flocking and base material shrinkage were performed in the same manner as that in Example 2 except that the voltage at the time of electrostatic flocking was set to 13 kV and the Zylon charge amount was set to 17%. A Zylon composite ester urethane resin sheet and a completely cured sheet were prepared by the same procedure as that in Example 13 except that as a binder resin liquid, a liquid prepared by mixing 100 parts by weight of a saturated copolymerized polyester urethane solution UR3575 available from TOYOBO CO., LTD. and 2.4 parts by weight of an epoxy resin HY-30 available from TOYOBO CO., LTD. was used. The volume resistivity of the completely cured sheet was determined to be greater than or equal to 10¹⁶ Ω·cm (measuring machine over range).

### Example 15

A Zylon composite acrylic resin sheet was prepared by the same procedure as that in Example 12 except that as a binder resin liquid, Yodosol AA76 (available from Henkel Japan Ltd.) which is an aqueous dispersion of an acrylic resin was used, and the heating for curing was performed for 1 hour at 80° C. The volume resistivity of the resin sheet was determined to be greater than or equal to 10¹⁶ Ω·cm (measuring machine over range).

### Example 16

A sheet was prepared in the same manner as that in Example 13 except that the adhesive coating thickness was set to 50 μm and the Zylon charge amount was set to 30%. The volume resistivity of the completely cured sheet was determined to be greater than or equal to 10¹⁶ Ω·cm (measuring machine over range).

### Example 17

A sheet was prepared in the same manner as that in Example 13 except that the voltage at the time of electrostatic flocking was set to 36 kV, the distance between electrodes was set to 6 cm and the Zylon charge amount was set to 25%. The volume resistivity of the completely cured sheet was determined to be greater than or equal to 10¹⁶ Ω·cm (measuring machine over range).

### Example 18

A sheet was prepared in the same manner as that in Example 13 except that the granularity of the abrasive paper was set to #600. The volume resistivity of the sheet was determined to be greater than or equal to 10¹⁶ Ω·cm (measuring machine over range).

### Reference Example 1

A sheet was prepared in the same manner as that in Example 2 except that the Zylon charge amount was set to 15%. The volume resistivity of the completely cured sheet was determined to be greater than or equal to 10¹⁶ Ω·cm (measuring machine over range).

### Reference Example 2

A sheet was prepared in the same manner as that in Example 2 except that the Zylon charge amount was set to 10%. The volume resistivity of the completely cured sheet was determined to be greater than or equal to 10¹⁶ Ω·cm (measuring machine over range).

### Comparative Example 1

Electrostatic flocking and base material shrinkage were carried out in the same manner as that in Example 2 except that the Zylon charge amount was set to 40%. At the time of shrinking the base material, the flexure was generated and a sheet in good condition failed to be obtained.

### Comparative Example 2

A sheet was prepared by the same procedure as that in Example 1 except that a silicone-based binder resin described in Example 1 was used as an adhesive, the coating thickness was set to 120 μm, and the adhesive was solidified under conditions of a temperature of 80° C. for 1 hour. At the time of shrinking the base material, the flexure was generated and a sheet in good condition failed to be obtained.

### Comparative Example 3

A sheet was prepared by the same procedure as that in Example 1 except that the voltage at the time of electrostatic flocking was set to 10 kV. At the time of shrinking the base material, the flexure was generated and a sheet in good condition failed to be obtained.

### Comparative Example 4

A Zylon composite ester urethane resin sheet and a completely cured sheet were prepared by the same procedure as that in Example 8 except that a polyethylene terephthalate film with a thickness of 50 μm was used as a base material, and the adhesive coating thickness was set to 120 μm.

### Comparative Example 5

A Zylon composite ester urethane resin sheet and a completely cured sheet were prepared by the same procedure as that in Example 8 except that a polyethylene terephthalate film with a thickness of 50 μm was used as a base material, and the adhesive coating thickness was set to 400 μm.

### Comparative Example 6

A Zylon composite ester urethane resin sheet and a completely cured sheet were prepared by the same procedure as that in Example 8 except that the voltage applied between electrodes was set to 10 kV.

### Comparative Example 7

A binder resin liquid similar to that in Example 7 and Zylon HM short fibers irradiated with an ion beam and then cut in the same manner were mixed so that the volume content rate of the Zylon HM short fibers would be 20%, and stirred for 5 minutes. A layer of the obtained Zylon composite resin liquid with a thickness of 100 μm was applied onto a polyethylene terephthalate film with a thickness of 50 μm, the film was arranged at the upper part of an earth electrode plate, and a voltage of 18 kV was applied between electrodes for 5 minutes, after which the layer was heated for 1 hour at 80° C. to be solidified. The Shore A hardness of the sheet was determined to be 68. The sheet was evaluated as V-0 in the UL 94 flame retardance test.

### Comparative Example 8

A Zylon composite silicone sheet was prepared by the same procedure as that in Example 7 except that Zylon HM not subjected to an electron beam treatment was used as an insulating highly heat-conductive fiber.

### Comparative Example 9

A Zylon composite ester urethane resin sheet was prepared by the same procedure as that in Example 8 except that Zylon HM not subjected to an electron beam treatment was used as an insulating highly heat-conductive fiber.

### Comparative Example 10

Electrostatic flocking and base material shrinkage were carried out in the same manner as that in Example 13 except that the Zylon charge amount was set to 40%. At the time of shrinking the base material, the flexure was generated and a sheet in good condition failed to be obtained.

### Comparative Example 11

A sheet was prepared by the same procedure as that in Example 13 except that a polyethylene terephthalate film with a thickness of 50 μm was used as a base material. At the time of shrinking the base material, the flexure was generated and a sheet in good condition failed to be obtained.

### Comparative Example 12

A Zylon composite ester urethane resin sheet and a completely cured sheet were prepared by the same procedure as that in Example 13 except that the adhesive coating thickness was set to 120 μm. At the time of shrinking the base material, the flexure was generated and a sheet in good condition failed to be obtained.

### Comparative Example 13

A sheet was prepared by the same procedure as that in Example 13 except that the voltage at the time of electrostatic flocking was set to 10 kV. At the time of shrinking the base material, the flexure was generated and a sheet in good condition failed to be obtained.

### Comparative Example 14

A binder resin liquid similar to that in Example 12 and Zylon HM short fibers irradiated with an ion beam and then cut in the same manner were mixed so that the volume content rate of the Zylon HM short fibers would be 20%, and stirred for 5 minutes. A layer of the obtained Zylon composite resin liquid with a thickness of 100 μm was applied onto SPACECLEAN^{&reg;} S7200 with a thickness of 20 μm, the base material was arranged on a positive electrode plate coated thinly with paraffin oil as a lubricant, and a voltage of 18 kV was applied between electrodes for 5 minutes, after which the layer was heated for 1 hour at 80° C. to be solidified. The Shore A hardness of the sheet was determined to be 68. The sheet was evaluated as V-0 in the UL 94 flame retardance test. At the time of shrinking the base material, the flexure was generated and a sheet in good condition failed to be obtained.

### Comparative Example 15

A Zylon composite silicone sheet was prepared by the same procedure as that in Example 12 except that Zylon HM not subjected to an electron beam treatment was used as an insulating highly heat-conductive fiber.

### Comparative Example 16

A Zylon composite ester urethane resin sheet was prepared by the same procedure as that in Example 13 except that Zylon HM not subjected to an electron beam treatment was used as an insulating highly heat-conductive fiber.

With regard to the sheets of Examples 1 to 18, since the ratio of the thermal conductivity in the thickness direction to the thermal conductivity in the planar direction is large and the sheets are very excellent in thermal anisotropy, even when the sheets are used as a heat-conductive sheet for electronic equipment having a high exothermic density, the amount of heat dissipated to the inside of the equipment is reduced and heat damage to a peripheral member is alleviated.

TABLE 1

| | | Shrinkage | | Adhesive | | Distance | | ZYLON |
|---|---|---|---|---|---|---|---|---|
| | | ratio [%] | | | Coating | between | | charge |
| | Base | Length/ | | | thickness | electrodes | Voltage | amount |
| | material | Breadth | Area | Material | [μm] | [cm] | [kV] | [%] |
| Example 1 | S7200 | 40/40 | 36 | Aqueous PVA | 25 | 3 | 18 | 25 |
| | | | | solution | | | | |
| Example 2 | | | | Aqueous PVA | 25 | 3 | 18 | 20 |
| | | | | solution | | | | |
| Example 3 | | | | Aqueous PVA | 25 | 3 | 13 | 17 |
| | | | | solution | | | | |
| Example 4 | | | | Aqueous PVA | 50 | 3 | 18 | 30 |
| | | | | solution | | | | |
| Example 5 | | | | Aqueous PVA | 25 | 3 | 36 | 25 |
| | | | | solution | | | | |
| Example 6 | | | | Aqueous PVA | 25 | 3 | 18 | 25 |
| | | | | solution | | | | |
| Reference | | | | Aqueous PVA | 25 | 3 | 18 | 15 |
| Example 1 | | | | solution | | | | |
| Reference | | | | Aqueous PVA | 25 | 3 | 18 | 10 |
| Example 2 | | | | solution | | | | |
| Comparative | | | | Aqueous PVA | 25 | 3 | 18 | 40 |
| Example 1 | | | | solution | | | | |
| Comparative | | | | Si rubber resin | 120 | 3 | 18 | 40 |
| Example 2 | | | | liquid | | | | |
| Comparative | | | | Aqueous PVA | 25 | 3 | 10 | 40 |
| Example 3 | | | | solution | | | | |

| | | | | | | Thermal | Thermal | Thickness/ |
|---|---|---|---|---|---|---|---|---|
| | | | | | | conductivity | conductivity | plane |
| | Angle [°] | | Flocking | Penetration | Surface | in planar | in thickness | thermal |
| | Before | After | density | density | roughness | direction | direction | conductivity |
| | shrinkage | shrinkage | [%] | [%] | [μm] | [W/mK] | [W/mK] | ratio |
| Example 1 | 74 | 85 | 20 | 54 | 4.5 | 0.60 | 26 | 43 |
| Example 2 | 71 | 81 | 18 | 47 | 1.5 | 0.75 | 20 | 27 |
| Example 3 | 62 | 78 | 13 | 32 | 2.0 | 0.85 | 12 | 14 |
| Example 4 | 71 | 81 | 20 | 51 | 0.8 | 0.75 | 20 | 27 |
| Example 5 | 79 | 85 | 21 | 58 | 1.1 | 0.61 | 26 | 43 |
| Example 6 | 75 | 85 | 21 | 53 | 8.6 | 0.70 | 26 | 37 |
| Reference | 70 | 75 | 9 | 19 | 1.3 | 0.71 | 8 | 11 |
| Example 1 | | | | | | | | |
| Reference | 68 | 73 | 10 | 25 | 1.8 | 0.90 | 10 | 11 |
| Example 2 | | | | | | | | |
| Comparative | 81 | x | 25 | x | x | — | — | — |
| Example 1 | | | | | | | | |
| Comparative | 48 | x | 5 | x | x | — | — | — |
| Example 2 | | | | | | | | |
| Comparative | 42 | x | 5 | x | x | — | — | — |
| Example 3 | | | | | | | | |

*) PVA: polyvinyl alcohol, Si rubber: silicone rubber

TABLE 2

| | | | Adhesive | | | Distance | | | |
|---|---|---|---|---|---|---|---|---|---|
| | | | | Coating | | between | Abrasive | Surface | Penetration |
| | Base | | | thickness | Voltage | electrodes | paper | roughness | density |
| | material | Binder | Material | [μm] | [kV] | [cm] | granularity | [μm] | [%] |
| Example 7 | Al | Si rubber | Aqueous PVA | 25 | 18 | 3 | #2000 | 4.5 | 30 |
| | | | solution | | | | | | |
| Example 8 | Al | UR3600 | Aqueous PVA | 25 | 18 | 3 | #2000 | 1.2 | 26 |
| | | | solution | | | | | | |
| Example 9 | Al | UR3537 | Aqueous PVA | 25 | 18 | 3 | #2000 | 2.1 | 26 |
| | | | solution | | | | | | |
| Example 10 | Al | Acrylic | Aqueous PVA | 25 | 18 | 3 | #2000 | 0.5 | 22 |
| | | | solution | | | | | | |
| Example 11 | Al | UR3600 | Aqueous PVA | 50 | 18 | 3 | #2000 | 0.8 | 20 |
| | | | solution | | | | | | |
| Comparative | PET | UR3600 | Si rubber resin | 120 | 18 | 3 | #2000 | 1.3 | 5 |
| Example 4 | | | liquid | | | | | | |
| Comparative | PET | UR3600 | Si rubber resin | 400 | 18 | 3 | #2000 | 1.5 | 3 |
| Example 5 | | | liquid | | | | | | |
| Comparative | Al | UR3600 | Aqueous PVA | 25 | 10 | 3 | #2000 | 1.8 | 5 |
| Example 6 | | | solution | | | | | | |
| Comparative | PET | Si rubber | — | — | 18 | 3 | — | — | 2 |
| Example 7 | | | | | | | | | |
| Comparative | Al | Si rubber | Aqueous PVA | 25 | 18 | 3 | #2000 | 4.4 | 26 |
| Example 8 | | | solution | | | | | | |
| Comparative | Al | UR3600 | Aqueous PVA | 25 | 18 | 3 | #2000 | 0.9 | 25 |
| Example 9 | | | solution | | | | | | |

| | | | | | | Retention ratio of dielectric | | | |
|---|---|---|---|---|---|---|---|---|---|
| | | | | | | breakdown strength after | | | |
| | | Thermal | Thermal | Thickness/ | Initial | durability test [%] | | | |
| | | conductivity | conductivity | plane | dielectric | | | | −40 to |
| | | in thickness | in planar | thermal | breakdown | 150° C. | 200° C. | 300° C. | 150° C. |
| | Angle | direction | direction | conductivity | strength | 3000 | 3000 | 3000 | 1500 |
| | [°] | [W/mK] | [W/mK] | ratio | [kV/mm] | hr | hr | hr | times |
| Example 7 | 71 | 11.9 | 1.1 | 10.8 | 31 | 98 | 98 | 60 | 87 |
| Example 8 | 74 | 9.4 | 0.9 | 10.4 | 38 | 100 | 95 | 75 | 76 |
| Example 9 | 70 | 9.2 | 1.2 | 7.7 | 28 | 95 | 95 | 59 | 75 |
| Example 10 | 70 | 9.4 | 1.0 | 9.4 | 35 | 95 | 95 | 69 | 69 |
| Example 11 | 63 | 5.1 | 2.1 | 2.4 | 31 | 100 | 95 | 59 | 76 |
| Comparative | 41 | 2.1 | 2.2 | 1.0 | 38 | 97 | 80 | 61 | 69 |
| Example 4 | | | | | | | | | |
| Comparative | 29 | 1.2 | 1.2 | 1.0 | 34 | 89 | 75 | 73 | 75 |
| Example 5 | | | | | | | | | |
| Comparative | 35 | 2.4 | 1.9 | 1.3 | 29 | 94 | 82 | 73 | 71 |
| Example 6 | | | | | | | | | |
| Comparative | 14 | 1.0 | 2.0 | 0.5 | 31 | 98 | 95 | 79 | 83 |
| Example 7 | | | | | | | | | |
| Comparative | 70 | 9.0 | 1.1 | 8.2 | 18 | 19 | 16 | 16 | 14 |
| Example 8 | | | | | | | | | |
| Comparative | 71 | 8.8 | 0.9 | 9.8 | 16 | 19 | 16 | 16 | 14 |
| Example 9 | | | | | | | | | |

*) Al: aluminum foil, PET: polyethylene terephthalate film, PVA: polyvinyl alcohol, Si rubber: silicone rubber

TABLE 3

| | | Shrinkage | | | | | Distance | |
|---|---|---|---|---|---|---|---|---|
| | | ratio [%] | | | Coating | | between | |
| | Base | Length/ | | Adhesive | thickness | | electrodes | Voltage |
| | material | Breadth | Area | Material | [μm] | Binder | [cm] | [kV] |
| Example 12 | S7200 | 40/40 | 36 | Aqueous PVA | 25 | Si rubber | 3 | 18 |
| | | | | solution | | | | |
| Example 13 | S7200 | 40/40 | 36 | Aqueous PVA | 25 | UR3600 | 3 | 18 |
| | | | | solution | | | | |
| Example 14 | S7200 | 40/40 | 36 | Aqueous PVA | 25 | UR3537 | 3 | 13 |
| | | | | solution | | | | |
| Example 15 | S7200 | 40/40 | 36 | Aqueous PVA | 25 | Acrylic | 3 | 18 |
| | | | | solution | | | | |
| Example 16 | S7200 | 40/40 | 36 | Aqueous PVA | 50 | UR3600 | 3 | 18 |
| | | | | solution | | | | |
| Example 17 | S7200 | 40/40 | 36 | Aqueous PVA | 25 | UR3600 | 6 | 36 |
| | | | | solution | | | | |
| Example 18 | S7200 | 40/40 | 36 | Aqueous PVA | 25 | UR3600 | 3 | 18 |
| | | | | solution | | | | |
| Comparative | S7200 | 40/40 | 36 | Aqueous PVA | 25 | UR3600 | 3 | 18 |
| Example 10 | | | | solution | | | | |
| Comparative | PET | — | — | Aqueous PVA | 25 | UR3600 | 3 | 18 |
| Example 11 | | | | solution | | | | |
| Comparative | S7200 | 40/40 | 36 | Aqueous PVA | 120 | UR3600 | 3 | 18 |
| Example 12 | | | | solution | | | | |
| Comparative | S7200 | 40/40 | 36 | Aqueous PVA | 25 | UR3600 | 3 | 10 |
| Example 13 | | | | solution | | | | |
| Comparative | S7200 | 40/40 | 36 | — | — | Si rubber | 3 | 18 |
| Example 14 | | | | | | | | |
| Comparative | S7200 | 40/40 | 36 | Aqueous PVA | 25 | Si rubber | 3 | 18 |
| Example 15 | | | | solution | | | | |
| Comparative | S7200 | 40/40 | 36 | Aqueous PVA | 25 | UR3600 | 3 | 18 |
| Example 16 | | | | solution | | | | |

| | | | | | | | | Thermal |
|---|---|---|---|---|---|---|---|---|
| | ZYLON | | | | | | | conductivity |
| | charge | Abrasive | Surface | Angle[°] | | Flocking | Penetration | in thickness |
| | amount | paper | roughness | Before | After | density | density | direction |
| | [%] | granularity | [μm] | shrinkage | shrinkage | [%] | [%] | [W/mK] |
| Example 12 | 25 | #2000 | 4.5 | 74 | 85 | 20 | 54 | 26.3 |
| Example 13 | 20 | #2000 | 1.5 | 71 | 81 | 18 | 47 | 20.9 |
| Example 14 | 17 | #2000 | 2.0 | 62 | 78 | 13 | 32 | 15.2 |
| Example 15 | 25 | #2000 | 0.5 | 70 | 81 | 19 | 22 | 13.4 |
| Example 16 | 30 | #2000 | 0.8 | 71 | 85 | 20 | 51 | 20.1 |
| Example 17 | 25 | #2000 | 1.1 | 79 | 85 | 21 | 58 | 26.3 |
| Example 18 | 25 | #600 | 8.6 | 75 | 75 | 21 | 53 | 26.5 |
| Comparative | 40 | #2000 | — | 81 | — | 25 | — | — |
| Example 10 | | | | | | | | |
| Comparative | 20 | #2000 | — | 48 | — | 5 | — | — |
| Example 11 | | | | | | | | |
| Comparative | 20 | #2000 | — | 29 | — | 8 | — | — |
| Example 12 | | | | | | | | |
| Comparative | 20 | #2000 | — | 42 | — | 5 | — | — |
| Example 13 | | | | | | | | |
| Comparative | 20 | — | — | 14 | — | 2 | — | — |
| Example 14 | | | | | | | | |
| Comparative | 25 | #2000 | 4.4 | 70 | 82 | 20 | 26 | 9.2 |
| Example 15 | | | | | | | | |
| Comparative | 20 | #2000 | 0.9 | 71 | 80 | 19 | 25 | 8.7 |
| Example 16 | | | | | | | | |

| | | | | Retention ratio of dielectric | | | |
|---|---|---|---|---|---|---|---|
| | | | | breakdown strength after | | | |
| | Thermal | Thickness/ | Initial | durability test [%] | | | |
| | conductivity | plane | dielectric | | | | −40 to |
| | in planar | thermal | breakdown | 150° C. | 200° C. | 300° C. | 150° C. |
| | direction | conductivity | strength | 3000 | 3000 | 3000 | 1500 |
| | [W/mK] | ratio | [kV/mm] | hr | hr | hr | times |
| Example 12 | 1.1 | 23.9 | 31 | 98 | 98 | 60 | 87 |
| Example 13 | 0.9 | 23.2 | 38 | 100 | 95 | 75 | 76 |
| Example 14 | 1.2 | 12.7 | 28 | 95 | 95 | 59 | 75 |
| Example 15 | 1.0 | 13.4 | 30 | 95 | 95 | 69 | 69 |
| Example 16 | 1.5 | 13.4 | 35 | 100 | 95 | 59 | 76 |
| Example 17 | 1.8 | 14.6 | 31 | 97 | 80 | 61 | 69 |
| Example 18 | 1.7 | 15.6 | 25 | 89 | 75 | 73 | 75 |
| Comparative | — | — | — | — | — | — | — |
| Example 10 | | | | | | | |
| Comparative | — | — | — | — | — | — | — |
| Example 11 | | | | | | | |
| Comparative | — | — | — | — | — | — | — |
| Example 12 | | | | | | | |
| Comparative | — | — | — | — | — | — | — |
| Example 13 | | | | | | | |
| Comparative | — | — | — | — | — | — | — |
| Example 14 | | | | | | | |
| Comparative | 1.1 | 8.4 | 15 | 19 | 16 | 16 | 14 |
| Example 15 | | | | | | | |
| Comparative | 0.9 | 9.7 | 13 | 19 | 19 | 16 | 14 |
| Example 16 | | | | | | | |

*) PET: polyethylene terephthalate film, PVA: polyvinyl alcohol

### INDUSTRIAL APPLICABILITY

It is made possible by the present invention to conduct heat and dissipate heat quickly and anisotropically from a heat generator such as an electronic board, a semiconductor chip and a light source to a cooling member, a housing and the like while ensuring the electrical insulation reliability, and as a result of alleviating the accumulation of heat within electronic equipment filled therewith, the present invention is expected to greatly contribute to the industrial world since the deterioration of electronic equipment, a light source and the like by heat is alleviated and the life thereof can be prolonged.

### REFERENCE SIGNS LIST

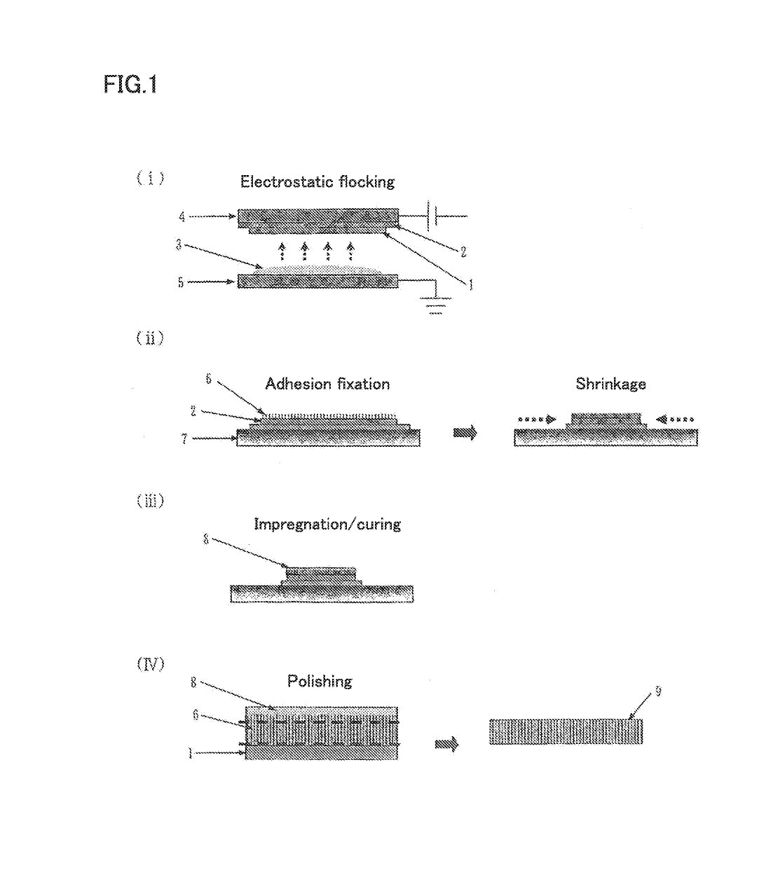

### FIG. 1

1 Adhesive
2 Base material film
3 Insulating highly heat-conductive short fiber
4 Positive electrode
5 Earth electrode
6 Erected insulating highly heat-conductive short fiber
7 Hot plate
8 Flocked sheet after shrinkage

1. An insulating heat-conductive sheet comprising:
insulating highly heat-conductive fibers penetrating in a thickness direction of the sheet; and
a binder resin,
wherein the insulating highly heat-conductive fibers penetrating in the thickness direction have a penetration density greater than or equal to 6%, and the insulating heat-conductive sheet has a ratio of thermal conductivity in the thickness direction to thermal conductivity in a planar direction greater than or equal to 2, and an initial dielectric breakdown strength greater than or equal to 20 kV/mm.

2. The insulating heat-conductive sheet according to claim 1, wherein the dielectric breakdown strength after the sheet is held at 150° C. for 3000 hours is greater than or equal to 30% of the initial dielectric breakdown strength.

3. The insulating heat-conductive sheet according to claim 1, wherein the average value of ratios of the thermal conductivity in the thickness direction to the thermal conductivity in the planar direction of said insulating heat-conductive sheet is greater than or equal to 2 and less than or equal to 50.

4. The insulating heat-conductive sheet according to claim 1, wherein the average value of tilt angles of said insulating heat-conductive fibers penetrating in the thickness direction relative to the sheet plane is greater than or equal to 60° and less than or equal to 90°.

5. The insulating heat-conductive sheet according to claim 1, wherein at least one sheet surface has a surface roughness less than or equal to 15 μm.

6. The insulating heat-conductive sheet according to claim 1, wherein the sheet has a durometer hardness less than or equal to the Shore A hardness of 80 and greater than or equal to the Shore E hardness of 5.

7. The insulating heat-conductive sheet according to claim 1, being evaluated as V-0 in the UL 94 flame retardance test.

8. The insulating heat-conductive sheet according to claim 1, wherein said insulating highly heat-conductive fiber penetrating in the thickness direction is any one of a boron nitride fiber, a high strength polyethylene fiber and a polybenzazole fiber.

9. The insulating heat-conductive sheet according to claim 1, wherein said binder resin is any one of a silicone-based resin, an acrylic resin, a urethane-based resin, an EPDM-based resin and a polycarbonate-based resin.

10. The insulating heat-conductive sheet according to claim 1, wherein said insulating highly heat-conductive fibers penetrating in the thickness direction have a penetration density greater than or equal to 6% and less than or equal to 50%.

11. An insulating heat-conductive sheet comprising:
insulating highly heat-conductive fibers penetrating in a thickness direction of the sheet; and
a binder resin,
wherein the insulating heat-conductive sheet has a ratio of thermal conductivity in the thickness direction to thermal conductivity in a planar direction greater than 12 and less than or equal to 50, the insulating highly heat-conductive fibers penetrating in the thickness direction have a penetration density greater than or equal to 6%, and the insulating heat-conductive sheet has a volume resistivity greater than or equal to 10¹² Ω·cm.

12. The insulating heat-conductive sheet according to claim 11, wherein said insulating highly heat-conductive fibers penetrating in the thickness direction have a penetration density greater than or equal to 30% and less than or equal to 70%.

13. The insulating heat-conductive sheet according to claim 11, wherein the average value of tilt angles of said insulating highly heat-conductive fibers penetrating in the thickness direction relative to the sheet plane is greater than or equal to 60° and less than or equal to 90°.

14. The insulating heat-conductive sheet according to claim 11, wherein at least one sheet surface has a surface roughness less than or equal to 15 μm.

15. The insulating heat-conductive sheet according to claim 11, being evaluated as V-0 in the UL 94 flame retardance test.

16. The insulating heat-conductive sheet according to claim 11, wherein said insulating highly heat-conductive fiber penetrating in the thickness direction is any one of a boron nitride fiber, a high strength polyethylene fiber and a polybenzazole fiber.

17. The insulating heat-conductive sheet according to claim 11, wherein said binder resin is any one of a silicone-based resin, an acrylic resin, a urethane-based resin, an EPDM-based resin and a polycarbonate-based resin.

18. A production method of an insulating heat-conductive sheet comprising the steps of:
subjecting insulating highly heat-conductive fibers to an easy adhesion treatment;
cutting the insulating highly heat-conductive fibers into an arbitrary length to give insulating highly heat-conductive short fibers;
erecting the insulating highly heat-conductive short fibers by electrostatic flocking on a base material coated with an adhesive;
adhering and fixing the erected insulating highly heat-conductive short fibers by heating, preferably shrinking the base material while or after adhering and fixing the erected insulating highly heat-conductive short fibers;
impregnating the erected insulating highly heat-conductive short fibers fixed on the base material with a binder resin and curing the binder resin; and
polishing both surfaces after the short fibers and the binder resin are peeled off from the base material or without peeling off the short fibers and the binder resin from the base material.

19. A production method of an insulating heat-conductive sheet comprising the steps of:
erecting insulating highly heat-conductive short fibers at a tilt angle of 60° to 90° relative to the sheet plane by electrostatic flocking on a base material coated with an adhesive;
destaticizing the erected insulating highly heat-conductive short fibers;
shrinking the base material at a shrinkage ratio making the penetration density less than or equal to 70% while or after adhering and fixing the erected insulating highly heat-conductive short fibers by heating;
impregnating the erected insulating highly heat-conductive short fibers fixed on the base material with a binder resin and solidifying the binder resin; and
polishing both surfaces after the short fibers and the binder resin are peeled off from the base material or without peeling off the short fibers and the binder resin from the base material.
